(19) United States
(12) Patent Application Publication
(10) Pub. No.: US 2026/0175862 A1
(43) Pub. Date: Jun. 25, 2026

(54) SMART COACHING OF A DRIVER

(71) Applicant: ALLSTATE INSURANCE COMPANY, NORTHBROOK, IL (US)

(72) Inventors: TIMOTHY W. GIBSON, BARRINGTON, IL (US); KATHERINE R. SWINDLER, CHICAGO, IL (US)

(21) Appl. No.: 19/419,219

(22) Filed: Dec. 15, 2025

Related U.S. Application Data
(60) Provisional application No. 63/736,896, filed on Dec. 20, 2024.

(51) Int. Cl. B60W 50/14; B60W 40/09; B60W 50/00

(52) U.S. Cl. CPC B60W 50/14; B60W 40/09; B60W 50/0097; B60W 2050/143; B60W 2050/146; B60W 2555/20; B60W 2556/10

(57) ABSTRACT

Methods, computer readable media, and computing platform for smart coaching of a driver of a vehicle are provided. A smart coaching program may control a computing device to receive drive data from a component in communication with the vehicle while a driver is driving the vehicle, the drive data indicative of one or more current characteristics of a drive trip of the vehicle, determine driver behavior of the driver from the drive data, generate a learning skill set by a machine learning model based on the determined driver behavior and deliver the learning skill set to the driver to improve driving skills of the driver.

### CROSS-REFERENCE TO RELATED APPLICATIONS

This claims priority to U.S. Provisional Patent Application No. 63/736,896, filed on Dec. 20, 2024, the entire contents of which are incorporated by reference herein.

### FIELD

This invention generally relates to computer systems and computer software that use artificial intelligence. More particularly, aspects of this disclosure provide a tool for smart coaching of a driver of a vehicle, the tool generating personalized feedback for the driver based on the driver's own driving behavior.

### BACKGROUND

Car accidents are a common cause of injury and damage, and the costs resulting from car accidents can be significant. The frequency of car accidents is especially high for young and/or novice drivers. There is a demand to reduce the number of accidents among this group of drivers. In the United States, many states require mandatory training for new drivers. This training may include attending classes and/or taking a driving course with a certified instructor. Further, in many states, prior to obtaining a driver's license, users may receive a driving permit that allows them to drive if another person with a valid driver's license is in the vehicle. Accordingly, new methods, devices, and software are desired to provide drivers with better driver training to reduce risky driving behavior.

### SUMMARY

Systems and methods for smart coaching of a driver of a vehicle are provided. Through the systems and methods described herein, insights obtained from vehicle telematics are leveraged to deliver personalized training to drivers. In particular, the personalized feedback is based on the driver's own driving behavior to target specific driving skills for practice in order to improve and reinforce driving skills of the novice driver.

The present disclosure provides, in one aspect, a computing platform that includes a processor, a communication interface communicatively coupled to the processor, and memory storing computer-readable instructions that, when executed by the processor, cause the computing platform to: receive drive data from a component in communication with the vehicle while the driver is driving the vehicle, the drive data indicative of current characteristics of a drive trip of the vehicle; determine driver behavior of the driver from the drive data; generate a learning skill set by a machine learning model based on the determined driver behavior; and deliver the learning skill set to the driver to improve driving skills of the driver.

The present disclosure provides, in another aspect, a computer-implemented method for smart coaching of a driver of a vehicle, the method including: receiving drive data from a component in communication with the vehicle while the driver is driving the vehicle, the drive data indicative of current characteristics of a drive trip of the vehicle; determining driver behavior of the driver from the drive data; generating a learning skill set by a machine learning model based on the determined driver behavior; and delivering the learning skill set to the driver after the drive trip is completed to improve driving skills of the driver.

The present disclosure provides, in another aspect, one or more non-transitory computer-readable media that includes one or more non-transitory computer-readable media storing instructions that, when executed by a computing platform comprising at least one processor, a communication interface, and memory, cause the computing platform to: receive drive data from a component in communication with the vehicle while the driver is driving the vehicle, the drive data indicative of current characteristics of a drive trip of the vehicle; determine driver behavior of the driver from the drive data; generate a learning skill set by a machine learning model based on the determined driver behavior; and deliver the learning skill set to the driver to improve driving skills of the driver

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals.

FIG. 1 illustrates an example operating environment for implementing a smart coaching system and methods as described herein.

FIG. 2 illustrates a block diagram of a computing device that can implement smart coaching systems and methods as described herein.

FIG. 3 illustrates a process flow diagram of a computer-implemented method for smart coaching of a driver of a vehicle.

FIG. 4 illustrates an example graphical user interface for a smart coaching application according to one embodiment.

FIG. 5 illustrates another example graphical user interface for a smart coaching application according to one embodiment.

FIG. 6 illustrates another example graphical user interface for a smart coaching application.

FIG. 7 illustrates a further example graphical user interface for a smart coaching application according to one embodiment.

### DETAILED DESCRIPTION

Systems and methods for smart coaching of a driver of a vehicle are provided. Through the systems and methods described herein, insights obtained from vehicle telematics are leveraged to deliver personalized training to drivers. In particular, the personalized training is based on the driver's own driving behavior to improve and reinforce driving skills of a novice driver. The system and method can be presented to the driver as an application program executing on a computing device. For example, the application program can provide feedback and coaching advice based on drive events that occur during drive trips driven by the driver.

Telematics includes the use of technology to communicate information from one location to another. Telematics has been used for various applications, including for the exchange of information with electronic sensors. As telematics technology has progressed, various communication methodologies have been incorporated into automobiles and other types of vehicles. Telematics systems such as on-board diagnostics (OBD) systems may be used in automobiles and other vehicles. OBD systems may provide information from the vehicle's on-board computers and sensors, allowing users to monitor a wide variety of information relating to the vehicle systems, such as vehicle speed, for example. Vehicles may also include global positioning systems (GPS) devices installed within or operating at the vehicle, configured to collect vehicle location and time data. Telematics devices installed within vehicles may be configured to access the vehicle computers, sensor data, and GPS device data and transmit the data to a display within the vehicle, a personal computer or mobile device, or to a centralized data processing system.

It is noted that various connections between elements are discussed in the following description. It is noted that these connections are general and, unless specified otherwise, may be direct or indirect, wired or wireless, and that the specification is not intended to be limiting in this respect.

The systems and methods described herein may utilize artificial intelligence and machine learning techniques. As described in more detail below, artificial intelligence techniques may be used to analyze large amounts of data. The artificial intelligence techniques can use machine learning models trained using a set of observations. The set of observations may be obtained from historical data, such as data gathered during one or more processes described herein. The machine learning models may include or may be included in a computing device, such as a user device or vehicle computing system.

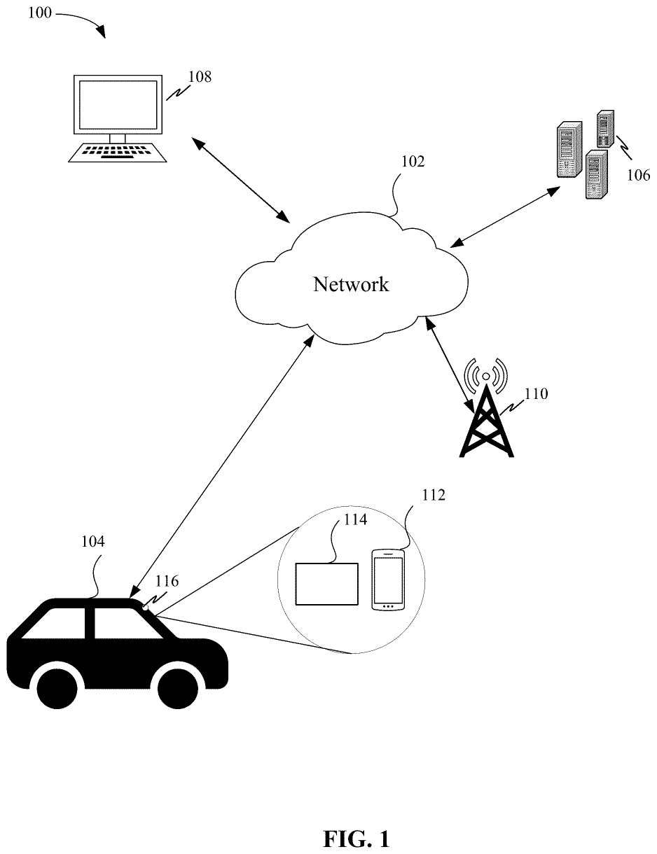

FIG. 1 illustrates an example operating environment for implementing a smart coaching system and methods as described herein. Referring to FIG. 1, operating environment 100 includes a network 102, an administrative computing device 108, servers 106, and a vehicle 104. The network 102 can be configured to connect computing devices within or associated with vehicle 104. Network 102 can be any type of network including a local area network (LAN) or a wide area network (WAN). Network 104 can include a cellular network and its components, such as base stations, cell towers, etc. In some cases, the network 104 can provide a path for connecting to application servers 106. Operating environment 100 can include access points 110 that extend the network 102 to reach mobile computing devices. The access points 110 can include cellular network components, global positioning system components, and other wireless access components (e.g., routers) for connecting computing devices within or associated with the vehicle 104.

One or more computing devices can be located within the vehicle 104. For example, vehicle 104 can include a driver computing device 112 and a vehicle computing device 114. The driver computing device 112 and the vehicle computing device 114 are shown for exemplary purposes only. Of course, more or less computing devices can be within or associated with the vehicle 104. Through the network 102, the driver computing device 112, e.g., a driver mobile device, and vehicle computing device 114, e.g., an on-board diagnostic system, may communicate with the application servers 106 to retrieve information such as driving statistics, maps, time of day, weather information, traffic information, position information, software updates, etc. The driver mobile device 112 may be positioned within the vehicle 104, e.g., on a center console or mounted on a flat surface so that its display can be seen by the driver but is not obstructing the view of the driving surface and external environment. The vehicle computing device 114 typically includes a display screen on the center console. In some cases, the driver mobile device 112 is coupled to the vehicle computing system 114 so that the driver mobile device 112 utilizes the display screen on the center console.

Vehicle 104 can include one or more sensing components 116. Currently, most vehicles include sensing components that collect drive data which can be any data related to a drive trip of the vehicle 104. For example, the drive data can be vehicle telematics data which describes multiple aspects of the vehicle's operation and how the vehicle is being driven. For example, the vehicle telematics data may include global positioning system (GPS) coordinates to allow the location of the vehicle to be tracked.

In order to gather drive data, sensing components 116 can be embodied as sensors positioned within or on the vehicle 104 or exist on a computing device, such the driver's mobile device 112, residing within the vehicle 104. For example, sensing components 116 can detect and store data corresponding to the vehicle's speed, distances driven, rates of acceleration or braking, geographic location, and/or specific instances of sudden acceleration, braking, and swerving. Sensing components 116 can also detect and store data received from the vehicle's internal systems, such as impact to the body of the vehicle 104, air bag deployment, headlights usage, brake light operation, door(s) opening and closing, door locking and unlocking, cruise control usage, hazard lights usage, windshield wiper usage, horn usage, turn signal usage, seat belt usage, phone and radio usage within the vehicle, maintenance performed on the vehicle, and other data collected by the vehicle's computer systems.

Additionally, drive data can include data describing the driving conditions of the vehicle 104. Sensing components 116 can detect and store conditions external to the vehicle 104 such as external temperature, rain, (e.g., using a rain sensor on the windshield), light levels, and sun position for driver visibility. Sensing components 116 can also detect, and store data related to moving violations and the observance of traffic signals and signs by the vehicle 104. Furthermore, internal cameras in the sensing components can detect conditions such as number of passengers in the vehicle 104 and other sources of distractions (e.g., pets, phone usage, unsecured objects in the vehicle). While many types of drive data have been described herein, sensing components can detect and store additional data about the vehicle's operation and driving conditions as drive data.

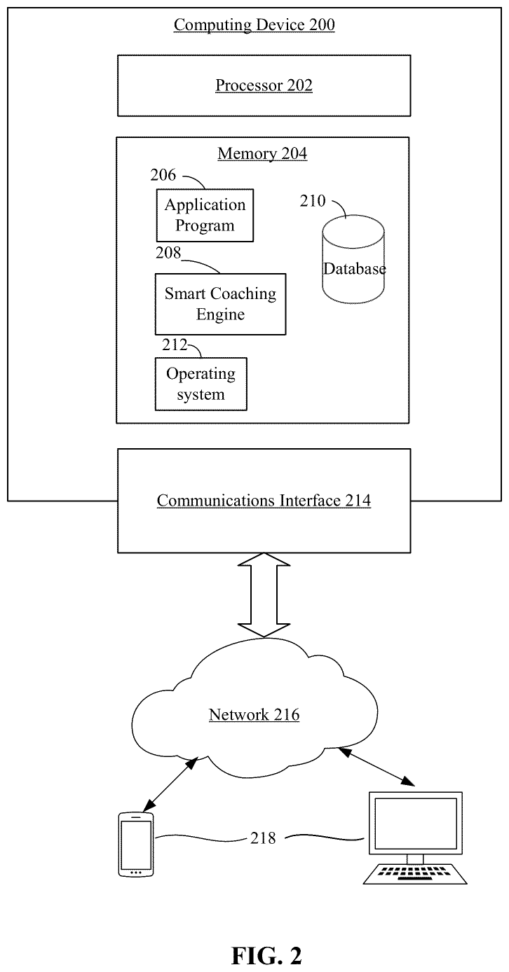

FIG. 2 illustrates a block diagram of an example computing device that can implement smart coaching systems and methods as described herein. Referring to FIG. 2, the computing device 200 can be similar to any available computing device, such as a personal computer (e.g., a desktop computer), server, laptop computer, notebook, tablet, smartphone, etc. The computing device 200 can include one or more processors 202, memory 204, and communications interface 214. A data bus may interconnect processors 202, memory 204, and communications interface 214. The communications interface 214 can be a network interface configured to support communication between the computing device 200 and one or more networks 216. Through the network 216, the computing device 200 may communicate with one or more remote computing devices 218 such as laptops, notebooks, smart-phones, personal computers, servers, etc.

The memory 204 can include operating system 212 and one or more application programs 206 having instructions that when executed by processor 202 cause the computing device 200 to perform one or more functions described herein and a database 210 that stores information which can be used by the application programs 206, processor 202, and operating system (OS) 212. In addition, the memory 204 can include smart coaching engine 208. Application program(s) 206 can perform methods executing instructions of a smart coaching program described herein.

The communications interface 214 can also include a user interface. The user interface may include user interface software and associated software (e.g., for graphics chips and input devices) executed by the OS 212 in support of the various user input and output devices. The associated software assists the OS 212 in communicating user interface hardware events to application programs using defined mechanisms. The user interface software may support a graphical user interface, a natural user interface, or any other type of user interface. The user interface may also include output devices such as a display screen(s), speakers, haptic devices for tactile feedback, and other types of output devices. In certain cases, input and output devices may be combined in a single device, such as a touchscreen display which both depicts images and receives touch gesture from the user.

With continued reference to FIG. 2, smart coaching engine 208 can include one or more machine learning models. The smart coaching engine 208 can include instructions that cause the computing device 200 to determine a driver learning skills set based on an input of driver behavior. Driver behavior can be determined by drive events informed by sensors coupled to the vehicle 104, for example.

The machine learning model of smart coaching engine 208 may utilize one or more tools, or one or more models such as, for example, a linear regression, a decision tree, a support vector machine, a random forest, a k-means algorithm, gradient boosting algorithms, gradient boosted tree model algorithm, dimensionality reduction algorithms, and the like. The machine learning model may be trained by the computing device 200 via supervised learning techniques, based on historical data. The historical data can include driver behaviors which the machine learning model can use to determine a personalized driver learning skills set for the driver. The driver behaviors can be past driver behaviors gathered and stored from the driver of the vehicle 104 or other generic driving behaviors. In some cases, the machine learning model or other models coupled to the machine learning model can be further trained on driving attributes. The driving attributes can include number of hours of practice logged to date, weather conditions, and driving conditions. Thus, the one or more machine learning models can include as input both driver behavior as well as defined driver attributes. Once the machine learning model demonstrates that it can accurately operate according to a defined standard (e.g., it can accurately determine an appropriate driving learning skills set for a driver based on the input), it can be deployed for use with the smart coaching system and methods described herein.

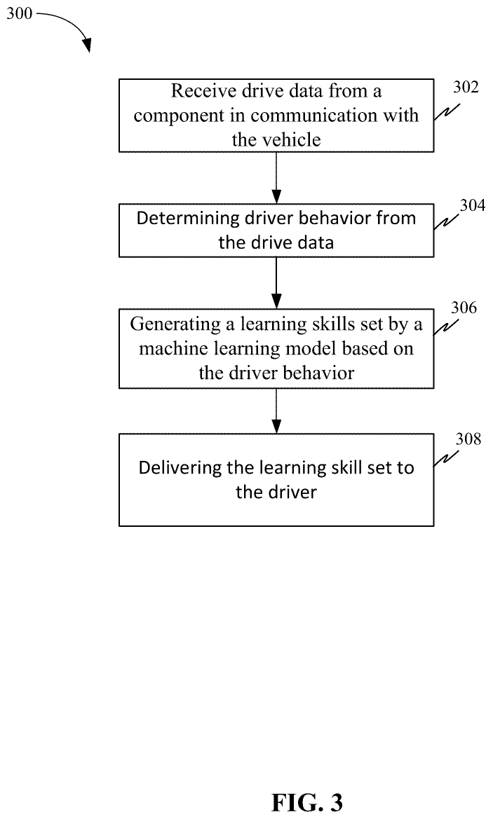

FIG. 3 illustrates a flow diagram of an example computer-implemented method for smart coaching of a driver. Method 300 can be performed by a computing device such as computing devices 112, 114, and 200 described with respect to FIG. 1 and FIG. 2. More specifically, FIG. 3 illustrates a plurality of steps a computing device may perform to provide a driver with smart coaching information that the driver can use to improve and reinforce driving skills. The smart coaching information can be in the form of a personalized learning skills set based on the driver's own driving behavior.

Referring to FIG. 3, the method 300 includes receiving (302) drive data from a component in communication with the vehicle while the driver is driving the vehicle, determining (304) driver behavior from the drive data, generating (306) a learning skill set based on the driver behavior, and delivering (308) the learning skill set to the driver.

Method 300 includes receiving (302) drive data captured from components in communication with the vehicle while the driver is driving the vehicle. The drive data is indicative of the current attributes of a drive trip of the vehicle. In some cases, the drive data can be sensed data, as described previously, captured from one or more sensors coupled to the vehicle while the driver is driving the vehicle. The one or more sensors can be directly coupled to the vehicle as well as sensors from one or more mobile computing devices within or associated with the vehicle. Attributes of the drive trip can include current weather conditions, road conditions, traffic conditions, braking data, turning data, speed data, acceleration/deceleration data, vehicle operation data, driver conditions (driver state/mood/alertness), vehicle telematics data, etc.

Method 300 further includes determining (304) driver behavior from the drive data. The driver behavior can be determined from drive events informed by the sensors. For example, drive events can include driving maneuvers, driving characteristics, and driving conditions. In some cases, driver behavior can be determined by comparing parameters of the drive event, e.g., a braking event, to a threshold or a range. The threshold or range can include standards for the drive event. The determined driver behavior can be stored in the memory to be used for further assessment and possibly be used for future training of the machine learning model.

Driving maneuvers can include braking, turning, accelerating, decelerating, swerving, changing lanes, parking tailgating, etc. As a detailed example, a braking event can be detected based deceleration data detected from an accelerometer. Algorithms can be used to determine the braking event from the deceleration data. For example, a braking event can be detected when the deceleration data exceeds a threshold, e.g., the vehicle speed decreased by 20 mph in a certain amount of time, and the vehicle's speed goes down to a minimum level, such as 1 mph. The driver behavior, in this example, would be that the driver is hard braking.

Driving characteristics can include driving speed, alertness of the driver, distracted driving, etc. As a simple example, it can be determined that the driver is speeding (driver behavior) based on the speed of the vehicle (drive event) and the posted speed limit for the driving location. Alertness of the driver as well as distracted driving can be determined from cameras located within the vehicle.

Driving conditions can include the time of day, weather, road conditions, etc. Driving conditions can be obtained by different means. External sensors can sense environmental conditions, e.g., solar detectors can detect sun exposure or and rain sensors can detect rain. However, weather data can also be obtained from satellite data communicated to the vehicle 104 via the computing devices 112, 114, 200.

Method 300 further includes generating (306) a learning skill set by a machine learning model based on the determined driver behavior. In some cases, the machine learning model is trained on driver behavior as described above. In other cases, the learning skill set can be generated by a machine learning model trained on driver behavior as well as driving attributes. The driving attributes can include weather data, amount of time driver has driven, and driving conditions.

Driving attributes can include the amount of time the driver has driven. The amount of time the driver has driven can be stored in a log. For example, the smart coaching program can track and store the time the driver has driven for a drive trip and then add that time to a counter that accumulates a total amount of time driven for the driver. The amount of time the driver has driven can help inform the machine learning model on driver experience. With the input of driver experience, the machine learning model can determine what driving skills can be expected of a driver having different levels of experience.

Weather data can include both historical e.g., almanac data describing typical weather for the time of year in the driving location, as well as real-time data received from satellites via a computing device executing the smart coaching application program. Thus, the learning skill set can be determined based on how the driver has driven in a weather type, e.g., snow, in the past or how the driver is currently driving in the weather. The learning skill set can then include lessons to prepare the driver for different driving conditions. For example, the learning skill set can include a lesson on how braking differs when driving on snow or ice.

In some cases, the determined driver behavior can be leveraged to determine a personalized learning skill set for the driver. The learning skills set can be accessed by the driver during or after the drive trip to improve and reinforce driving skills. In some cases, the learning skill set can be accessed by the driver on a mobile computing device via an application program. In other cases, the learning skill set can be accessed by the driver on the vehicle computing device. Additionally, the personalized learning skill set can be accessed by the driver on a computing device, such as a laptop device outside of the vehicle.

Thus, the learning skill set can provide personalized content encompassing a diversity of practice for the driver. The learning skill set can comprise lesson plans, tips, insights, reports, and assessments based on the driver's own behavior to improve and reinforce driver skills. In some cases, the learning skill set can be presented to the driver after the drive trip via text or video instruction on a graphical user interface of a computing device. In other cases, the learning skill set can be presented auditorily from the computing device to the driver while the driver is behind the wheel so that the driver can familiarize himself/herself with components of the vehicle or provide step-by-step lessons, for example.

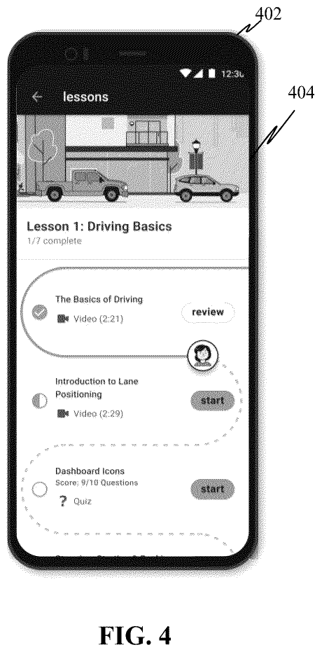

In some cases, the learning skill set can include lesson plans. The lesson plans can be a personalized combination of videos, quizzes and hands-on driving exercises organized into lessons for the driver. FIG. 4 illustrates an example graphical user interface for a smart coaching application according to one embodiment. Referring to FIG. 4, computing device 402 includes graphical user interface (GUI) 404 displaying an example lesson for a teen driver, or a driver with little to no driving experience. The lesson can include a video on the basics of driving, an introduction to lane positioning, as well as dashboard icon quiz as shown on the GUI of FIG. 4. The video content can include tutorials that follow the creative best practices of social platforms that many teenagers are familiar with to include digestible, short form videos, relatable language, energetic edits, and stickers and overlays. In some cases, the lesson plans can be informed by research done regarding recommendations to help prevent teen accidents and improve road safety. While pre-license teenage drivers are a targeted group for some lesson plans, the lesson plans can be tailored to other populations of drivers as well. In some cases, the lessons can be delivered via a computing device 112, 114 within the vehicle 104 for behind-the-wheel exercises. The lessons can be optimized for Apple CarPlay® and Android Auto integration which guide drivers step-by-step through driving basics.

Method 300 further includes delivering (308) the learning skill set to the driver within the vehicle to the driver. The learning skill set is delivered to the driver via a display on a computing device. In some cases, learning skill set can be delivered to the driver through one of the computing devices in the vehicle.

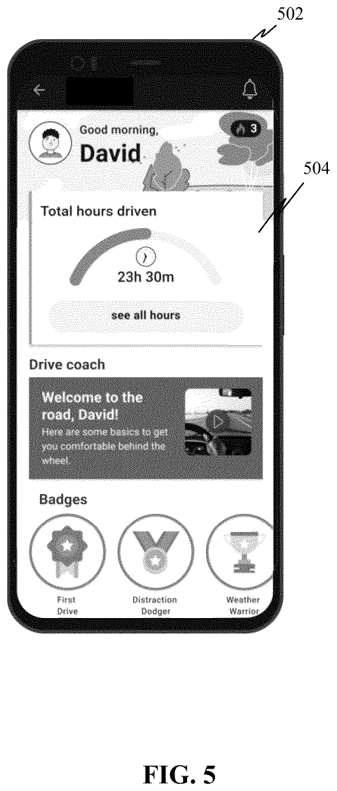

FIG. 5 illustrates another example graphical user interface for a smart coaching application according to one embodiment. Referring to FIG. 5, the graphical user interface 504 can be a display of a smartphone 502 and can provide the user, e.g., David in this case, with personalized content that includes basic lessons for a novice driver with little or no historical past driver behavior. In the illustrated example, the smart coaching program provides video content of some tips to get comfortable behind the wheel. Additionally, the graphical user interface 504 can display the total hours driven and rewards in the form of badges.

The smart coaching program can store data, e.g., driver behavior and driving attributes, gathered during a drive trip. In some cases, the method 300 can include aggregating the stored data and produce a report for the drive trip, time period (a week), and/or accumulated from the time the driver started using the smart coaching program. The report for the drive trip can be transmitted across the network 102 and accessed via the computing devices 112, 114, 200 or the remote computing devices 218 by the driver and/or another person associated with the driver.

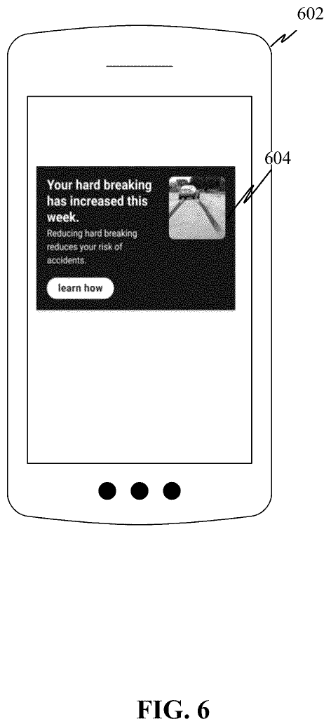

The reports can provide feedback to the driver on driving performance and how the driver is progressing. For example, feedback found in the report can include driver performance improvement on certain skills or driving skills that are not improving where remediation with additional skills training may be needed. FIG. 6 illustrates another example graphical user interface according to an embodiment. For example, FIG. 6 illustrates a graphical user interface 604 of computing device 602 with a report that includes that the driver's hard braking (driver behavior) increased for the week as compared to another time period, e.g., last week, for example. The learning skill set can further include remediation in the form of lesson plans to practice hard braking skills, thereby reducing the risks of accidents.

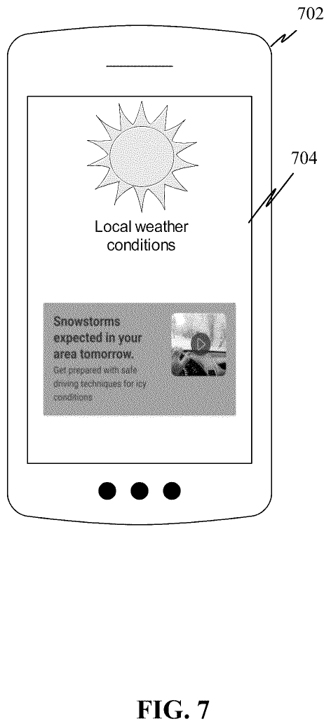

FIG. 7 illustrates a further example graphical user interface for a smart coaching application according to one embodiment. Referring to FIG. 7, current weather can be displayed on the graphical user interface 704 of computing device 702 as well as forecast weather for tomorrow. In the illustrated scenario, the weather tomorrow is forecast to include snowstorms. In this scenario, the learning skills set includes a lesson detailing safe driving techniques for icy conditions presented via video instruction.

Moreover, the machine learning model may predict a future drive event for the driver based on the determined driver behavior and the driving attributes. The learning skills set is then generated based on this predicted future drive event. For example, the machine learning model can utilize past driver behavior and weather data to predict a drive event, e.g., driving in snow because at the current location, it snows in the winter, and then determine based on stored driver behavior and/or drive events that the driver has not yet driven in snow. The smart coaching application via the machine learning model can then suggest a learning skill set with driving lessons for driving in snow personalized for the driver.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A computing platform, comprising:
a processor;
a communication interface communicatively coupled to the processor; and
memory storing computer-readable instructions that, when executed by the processor, cause the computing platform to:
receive drive data from a component in communication with the vehicle while the driver is driving the vehicle, the drive data indicative of current characteristics of a drive trip of the vehicle;
determine driver behavior of the driver from the drive data;
generate a learning skill set by a machine learning model based on the determined driver behavior; and
deliver the learning skill set to the driver to improve driving skills of the driver.

2. The computing platform as claimed in claim 1, wherein the learning skill set includes one or more of lesson plans, tips, insights, reports, and assessments.

3. The computing platform as claimed in claim 1, wherein the learning skill set is delivered to the driver via a display on a computing device.

4. The computing platform as claimed in claim 3, wherein the learning skill set is delivered by video instruction via the computing device.

5. The computing platform as claimed in claim 1, wherein the learning skill set is delivered auditorily via the computing device.

6. A computer-implemented method for smart coaching of a driver of a vehicle, comprising:
receiving drive data from a component in communication with the vehicle while the driver is driving the vehicle, the drive data indicative of current characteristics of a drive trip of the vehicle;
determining driver behavior of the driver from the drive data;
generating a learning skill set by a machine learning model based on the determined driver behavior; and
delivering the learning skill set to the driver after the drive trip is completed to improve driving skills of the driver.

7. The computer-implemented method as claimed in claim 6, wherein receiving drive data from a component in communication with the vehicle while the driver is driving the vehicle comprises receiving sensed data captured from sensors coupled to the vehicle.

8. The method as claimed in claim 6, wherein determining driver behavior from the drive data includes comparing a drive event captured by the sensors during the drive trip to a threshold defining a standard for the drive event.

9. The method as claimed in claim 6, wherein generating the learning skill set by the machine learning model is based on the determined driver behavior and driving attributes, wherein the driving attributes include weather data, amount of time driver has driven, and driving conditions.

10. The method as claimed in claim 6, wherein the machine learning model is trained using historical data related to drive behaviors.

11. The method as claimed in claim 10, wherein the machine learning model is further trained using driving attributes, wherein the driving attributes include weather data, amount of time driver has driven, and driving conditions.

12. The method as claimed in claim 6, further comprising predicting, by the machine learning model, a future drive event for the driver based on the determined driver behavior and the driving attributes, and wherein the learning skill set is generated based on the predicted future drive event.

13. The method as claimed in claim 6, wherein delivering the learning skills set after the drive trip comprises displaying the learning skills set to the driver on a computing device.

14. The method as claimed in claim 13, wherein delivering the learning skill set after the drive trip includes providing video instruction to the driver via the computing device.

15. The method as claimed in claim 6, further comprising storing the driver behavior during the drive trip and aggregating the stored driver behavior to produce a report.

16. One or more non-transitory computer-readable media storing instructions that, when executed by a computing platform comprising at least one processor, a communication interface, and memory, cause the computing platform to:
receive drive data from a component in communication with the vehicle while the driver is driving the vehicle, the drive data indicative of current characteristics of a drive trip of the vehicle;
determine driver behavior of the driver from the drive data;
generate a learning skill set by a machine learning model based on the determined driver behavior; and
deliver the learning skill set to the driver to improve driving skills of the driver.

17. The computer-readable media as claimed in claim 16, wherein the drive data is received from a component in communication with the vehicle while the driver is driving the vehicle comprises receiving sensed data captured from sensors coupled to the vehicle.

18. The method as claimed in claim 16, wherein driver behavior is determined from the drive data and includes comparing a drive event captured by the sensors during the drive trip to a threshold defining a standard for the drive event.

19. The method as claimed in claim 16, wherein the learning skill set is generated by the machine learning model based on the determined driver behavior and driving attributes, wherein the driving attributes include weather data, amount of time driver has driven, and driving conditions.

20. The method as claimed in claim 16, wherein the machine learning model is trained using historical data related to drive behaviors.
